(19) United States
(12) Patent Application Publication
(10) Pub. No.: US 2020/0292567 A1
(43) Pub. Date: Sep. 17, 2020

(54) INTEGRATED SYSTEM FOR PROCESSING VESSELS CONTAINING SAMPLES

(71) Applicant: SCP SCIENCE, Baie d'Urfe (CA)

(72) Inventors: George FEILDERS, Beaconsfield (CA); Art ROSS, Selkirk (CA); Pieter ROOS, Lasalle (CA); Guobin MA, Dorval (CA)

(21) Appl. No.: 16/817,797

(22) Filed: Mar. 13, 2020

Related U.S. Application Data
(60) Provisional application No. 62/818,908, filed on Mar. 15, 2019.

(51) Int. Cl. G01N 35/04; G01N 35/10

(52) U.S. Cl. CPC G01N 35/04; G01N 2035/00445; G01N 35/1002

(57) ABSTRACT

There is described an integrated system for processing vessels containing samples. The integrated system generally has: a frame; a reagent dispensing station, a sample digestion station, a sample cooling station, a sample normalization station and a sample filtration station within the frame; a vessel manipulation unit having a vessel manipulating member displacing the vessels containing the samples between the reagent dispensing station, the sample digestion station, the sample cooling station, the sample normalization station and the sample filtration station; and a controller communicatively coupled to the vessel manipulation unit, the controller having a processor and a memory having stored thereon instructions which when executed by the processor displace the vessels containing the samples from one station to another.

### CROSS-REFERENCE TO RELATED APPLICATIONS

The present application claims the benefit of U.S. Provisional Patent Application No. 62/818,908 filed on Mar. 15, 2019, the contents of which are hereby incorporated by reference.

### TECHNICAL FIELD

The present disclosure relates generally to integrated systems for analytical chemistry, and more particularly for processing samples contained in vessels.

### BACKGROUND OF THE ART

Various systems are used in laboratories to process samples received in open vessels, as the processing includes many different steps. The systems are typically spaced-apart and independent from one another. Accordingly, during use, an operator moves the vessels from one independent station to another.

Although existing vessel processing systems are satisfactory to a certain degree, there remains room for improvement, especially in reducing the amount of manipulations required by the operator to process the samples satisfactorily.

### SUMMARY

In accordance with a broad aspect, there is provided an integrated system for processing vessels containing samples. The integrated system comprises: a frame; a reagent dispensing station, a sample digestion station, a sample cooling station, a sample normalization station and a sample filtration station within the frame; a vessel manipulation unit having a vessel manipulating member displacing the vessels containing the samples between the reagent dispensing station, the sample digestion station, the sample cooling station, the sample normalization station and the sample filtration station; and a controller communicatively coupled to the vessel manipulation unit, the controller having a processor and a memory having stored thereon instructions which when executed by the processor displace the vessels containing the samples from one station to another.

In some embodiments, the instructions are further executable for performing operations on the samples in the vessels, such as digestion, normalization, filtration, reagent dispensing, and cooling.

Features of the systems, devices, and methods described herein may be used in various combinations, in accordance with the embodiments described herein.

### BRIEF DESCRIPTION OF THE DRAWINGS

Reference is now made to the accompanying figures in which:

FIG. 1 is a block diagram of an example of an integrated system for processing vessels, in accordance with one or more embodiments;

FIG. 2 is a perspective view of another example of an integrated system for processing vessels, in accordance with one or more embodiments;

FIG. 3 is a perspective view of vessels held together by a vessel holder, for use with an integrated system, in accordance with one or more embodiments;

FIG. 4 is a view of a vessel, in accordance with one or more embodiments;

FIG. 5 is a view of a vessel manipulation member, in accordance with one or more embodiments;

FIG. 6 is a view of an integrated system with the vessels in a vessel holder held by the vessel manipulation member of FIG. 5, in accordance with one or more embodiments;

FIG. 7 is a sectional view of the integrated system of FIG. 2, taken at line 7-7, in accordance with one or more embodiments;

FIG. 8 is a view of an integrated system with the vessels at a sample digestion station, in accordance with one or more embodiments;

FIG. 9A is a top perspective view of an evaporation stopper plate, in accordance with one or more embodiments;

FIG. 9B is a bottom perspective view of an evaporation stopper plate, in accordance with one or more embodiments;

FIG. 10 is a view of an integrated system with vessels at a reagent dispensing station, at a sample cooling station and at a sample normalization station, in accordance with one or more embodiments;

FIG. 11 is an exploded view of an example of a filtering system of the sample filtration station of an integrated system, in accordance with one or more embodiments;

FIG. 12 is a view of an integrated system showing the vessels at a sample filtration station, in accordance with one or more embodiments;

FIG. 13 is a sectional view of the integrated system of FIG. 2, taken at line 13-13, in accordance with one or more embodiments; and

FIGS. 14A and 14B show an example of a fluid blower of the ventilation unit, in accordance with one or more embodiments.

It will be noted that throughout the appended drawings, like features are identified by like reference numerals.

### DETAILED DESCRIPTION

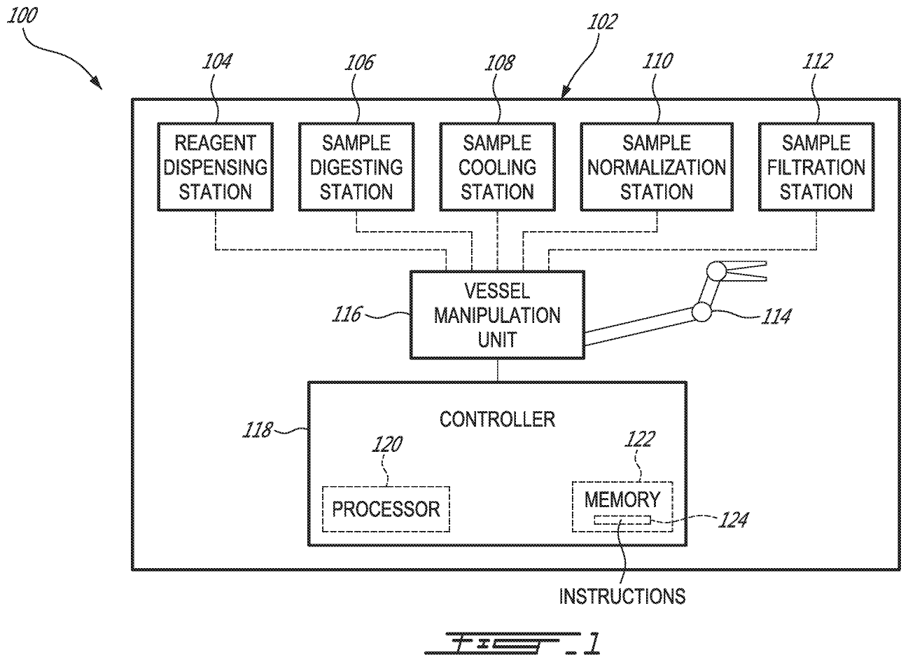

FIG. 1 shows an example of an integrated system 100 for processing vessels containing samples, in accordance with one or more embodiments. The integrated system 100 may be used to reduce the amount of manipulations required by operates in order to process samples and/or reduce the amount of samples needed to reach a given objective, i.e. perform reliable element analysis contained in the sample.

In some embodiments, the vessels can be vessels for small volumes, such as but not limited to 2 mL, 5 mL, 12 mL, 15 mL, and the like. As depicted, the integrated system 100 can have a frame 102 within which are provided a reagent dispensing station 104, a sample digestion station 106, a sample cooling station 108, a sample normalization station 110 and a sample filtration station 112.

The reagent dispensing station 104 can be used to receive the vessels and to dispense reagent inside each one of the vessels so that the reagent can react with the samples contained therein. An example type of reagent can include corrosive acid(s) and the like. Any other suitable reagent can be considered.

In some embodiments, the reagent dispensing station 104 can be configured to mix the dispensed reagent within the samples inside the vessels. For instance, the reagent dispensing station 104 can shake the vessels for a predetermined period of time in order to mix the dispensed reagent within the samples in a satisfactory manner. In some other embodiments, the samples can be mixed using a magnetic stirrer, a bubble stirring mechanism and any other mixing techniques.

The volume and/or the type of dispensed reagent can be the same for all vessels. However, in some other embodiments, the volume and/or the type of dispensed reagent can be different for each one, or a subset, of the vessels. For instance, the volume and/or the type of dispensed reagent can be a function of the remaining volume and/or of the type of sample inside each one of the vessels. Other implementations may also apply.

The sample digestion station 106 can be used to digest the samples contained inside each one of the vessels. An example type of digestion can require heating the vessels. Another example type of digestion can require radiating microwave and/or infrared radiation across each of the vessels. Another type of digestion can involve both heating the vessels and radiating the vessels with a given type of radiation. In these embodiments, digestion conditions can include, but are not limited to, a given temperature at which the vessels are heated, a rate at which the temperature is raised, a given period of time during which the vessels are heated/radiated, a given spectral content of the radiation and/or a given power of the radiation, and the like.

The digestion type and/or the digestion conditions can depend on the application. For instance, in some embodiments, the digestion type and/or digestion conditions can be suited for trace metal digestion, cyanide determination, digestion for chemical oxygen demand, and the like. Other implementations may apply.

The sample cooling station 108 can be used to cool the samples contained inside each one of the vessels. The cooling can be passive or active depending on the embodiment. For instance, the vessels can be passively cooled by letting them interact with surrounding air, by which the temperature of the samples can tend towards the ambient temperature. In other embodiments, the vessels can be actively cooled by blowing surrounding air towards the vessels, which can increase a cooling rate at which the vessels tend to the ambient temperature. In other embodiments, the vessels can be actively cooled by sucking away hot air from the vessels, which can increase a cooling rate at which the vessels tend towards an ambient temperature. In alternate embodiments, the vessels can be actively cooled by blowing cold pressure air towards the vessels and/or by cooling the vessels via a thermoelectric cooling element involving the thermoelectric Peltier effect, which may cool the vessels to a temperature below the ambient temperature, if desired. The sample cooling station 108 can be configured to maintain the vessels at a desired temperature for a given period of time once they have reached the desired temperature.

The cooling type and/or the cooling conditions can vary from one embodiment to another. For instance, it can be desirable to cool the vessels rapidly in some embodiments whereas the cooling rate of the vessels is insignificant in other embodiments.

The sample normalization station 110 can be used to determine remaining volumes Vᵣ of the samples inside each of the vessels and to normalize the volumes of the samples to a predetermined normalized level Vₙ. The normalization step can be performed by adding a given volume Vₐ of a normalization fluid inside each of the vessels corresponding to the predetermined normalized level Vₙ minus the remaining volume Vₙ as measured (Vₐ=Vₙ−Vᵣ). Example types of normalization fluid can include, but are not limited to, deionized water, distilled water, internal standard, and the like. In some embodiments, all the vessels can be normalized simultaneously whereas in other embodiments, the vessels can be normalized sequentially or by subset.

The sample filtration station 112 can be used to filter the samples of the vessels. For instance, the processing steps such as the reagent dispensing, digestion, cooling and normalization steps can cause solids to form inside the vessels. The samples can be filtered into a solid part and a fluid part. The fluid part can be provided in corresponding recipient vessels, thereby allowing other processing steps to be carried out independently on either one or both of the solid and fluid parts of the filtered samples. The sample filtration station 112 can be configured to perform the filtering of the samples on an individual and independent basis, to avoid any possible contamination between the samples. Examples of filtration types can include, but are not limited to, gravity filtration, vacuum filtration, cold filtration, hot filtration, decantation and/or separation. Other types of filtration can be considered. The sample filtration station 112 can also be configured to perform filtering of all the samples simultaneously.

The integrated system 100 can have a vessel manipulation unit 116 with a vessel manipulating member 114 moving between the reagent dispensing station 104, the sample digestion station 106, the sample cooling station 108, the sample normalization station 110 and the sample filtration station 112.

In some embodiments, the vessel manipulation member 114 can have one or more vessel engaging features which can engage the vessels, directly or indirectly, in order to move them from one station to another, collectively or individually. Examples of such engaging features can include, but are not limited to, one or more pushing members, one or more pulling members, one or more gripping members, one or more lifting platforms, one or more hook and loop features, one or more groove and tongue features, and/or any other suitable engaging arrangements. In some embodiments, the vessel engaging features can be provided at an end of a robotized arm. In these embodiments, the robotized arm can be articulated to move freely in up to six degrees of freedom, for instance. Other vessel manipulation members can also be considered. For instance, one or more conveyors can be used to move the vessels from one station to another.

A controller 118 is provided to control the vessel manipulation unit 116 to move the vessel manipulation member 114 from one station to another. In some embodiments, the controller 118 can be configured to operate one or more of the reagent dispensing station 104, the sample digestion station 106, the sample cooling station 108, the sample normalization station 110 and the sample filtration station 112.

The controller 118 can be communicatively coupled to the vessel manipulation unit 116 via a wired connection. However, in some other embodiments, the controller 118 can be communicatively coupled to the vessel manipulation unit 116 via a wireless connection, or a combination of both a wired connection and a wireless connection.

As depicted, the controller 118 can have a processor 120 and a memory 122 having stored thereon instructions 124 which when executed by the processor 120 perform steps of moving the vessel manipulating member 114 from one station to another to process vessels at the station where they are moved, and/or perform operations on the samples inside the vessels, e.g. adding agent, digestion, normalization, etc.

The processor 120 may comprise any suitable devices configured to implement the steps described herein such that instructions 124, when executed by the controller 118 or other programmable apparatus, may cause the functions/acts/steps performed to be executed. The processor 120 may comprise, for example, any type of general-purpose microprocessor or microcontroller, a digital signal processing (DSP) processor, a central processing unit (CPU), a graphical processing unit (GPU), an integrated circuit, a field programmable gate array (FPGA), a reconfigurable processor, other suitably programmed or programmable logic circuits, or any combination thereof.

The memory 122 may comprise any suitable known or other machine-readable storage medium. The memory 122 may comprise non-transitory computer readable storage medium, for example, but not limited to, an electronic, magnetic, optical, electromagnetic, infrared, or semiconductor system, apparatus, or device, or any suitable combination of the foregoing. The memory 122 may include a suitable combination of any type of computer memory that is located either internally or externally to the controller, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory 122 may comprise any storage means (e.g., devices) suitable for retrievably storing machine-readable instructions 124 executable by processor 120.

Depending on the embodiment, the controller 118 can be communicatively coupled, via a wired and/or wireless connection, to one or more of the reagent dispensing station 104, the sample digestion station 106, the sample cooling station 108, the sample normalization station 110 and the sample filtration station 112, for controlling thereof, examples of which are described below.

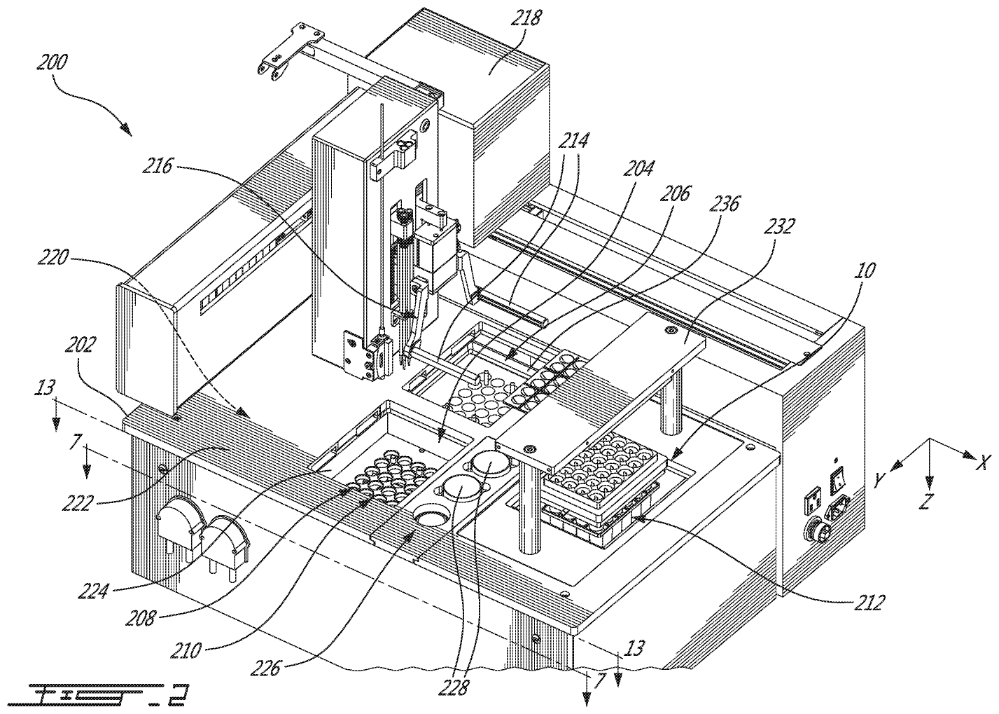

FIG. 2 shows another example of an integrated system 200. As depicted, the integrated system 200 can have a frame 202 to which are made integral a reagent dispensing station 204, a sample digestion station 206, a sample cooling station 208, a sample normalization station 210 and a sample filtration station 212.

In the illustrated example, the reagent dispensing station 204, the sample cooling station 208 and the sample normalization station 210 share a first vessel receiving region 224 on a top surface 222 of the frame 202. The sample digestion station 206 is at a second vessel receiving region 236 on the top surface 222 of the frame 202. As shown, the first region 224 can be spaced-apart from the second region 236, which can avoid any potential risk (e.g., dropping reagent on a heating element). In alternate embodiments, each of the reagent dispensing station 204, the sample digestion station 206, the sample cooling station 208, the sample normalization station 210 and the sample filtration station 212 can have its own region on the top surface 222 of the frame 202, if desired.

In this example, the frame is provided in the form of a housing inside which are enclosed parts of the integrated system. For instance, the integrated system can have a controller 218 enclosed within the housing.

In this specific example, the controller 218 is communicatively coupled to the vessel manipulation unit 216, the reagent dispensing station 204, the sample digestion station 206, the sample cooling station 208, the sample normalization station 210 and the sample filtration station 212. The controller 218 can also be communicatively coupled to a ventilation unit 220, which will be described below in detail.

Similarly to the integrated system 100 of FIG. 1, the integrated system 200 of FIG. 2 can have a vessel manipulation unit 216 with a vessel manipulating member 214 displaceable between the reagent dispensing station 204, the sample digestion station 206, the sample cooling station 208, the sample normalization station 210 and the sample filtration station 212.

In this specific embodiment, the integrated system 200 can have a washing station 226 and one or more reagents reservoirs 228 recessed from the top surface 222 of the frame 202. The sample filtration station 212 may comprise a filtering system 10 and a vessel pressing plate 232, which will be explained in more detail below.

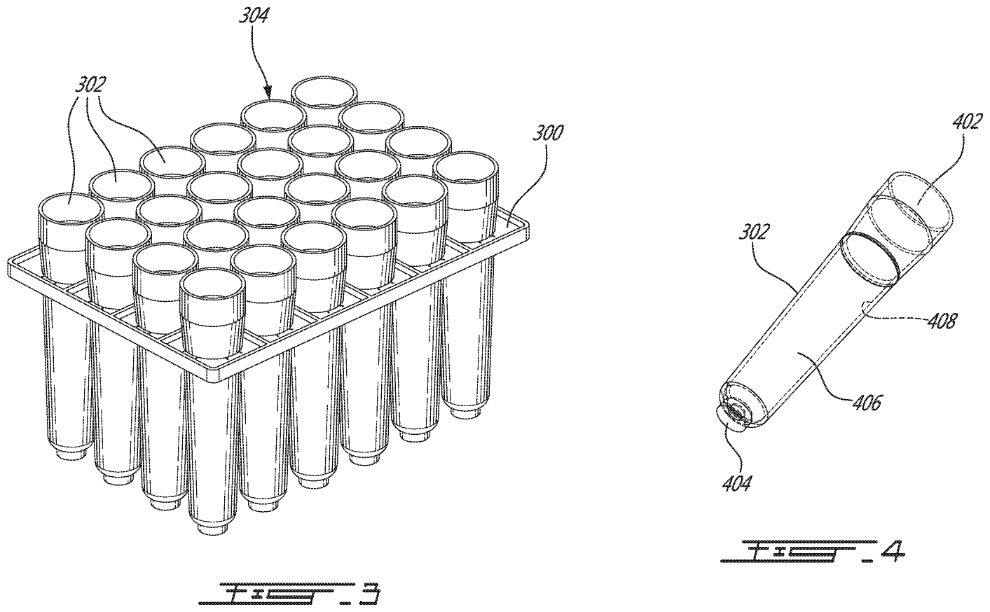

FIG. 3 shows an example of vessels 302 that can be processed using an integrated system, such as the integrated systems 100, 200 of FIGS. 1 and 2. As illustrated, the vessels 302 are held together by a vessel holder 300. In this example, the vessel holder 300 can have vessel apertures receiving corresponding vessels 302 therein.

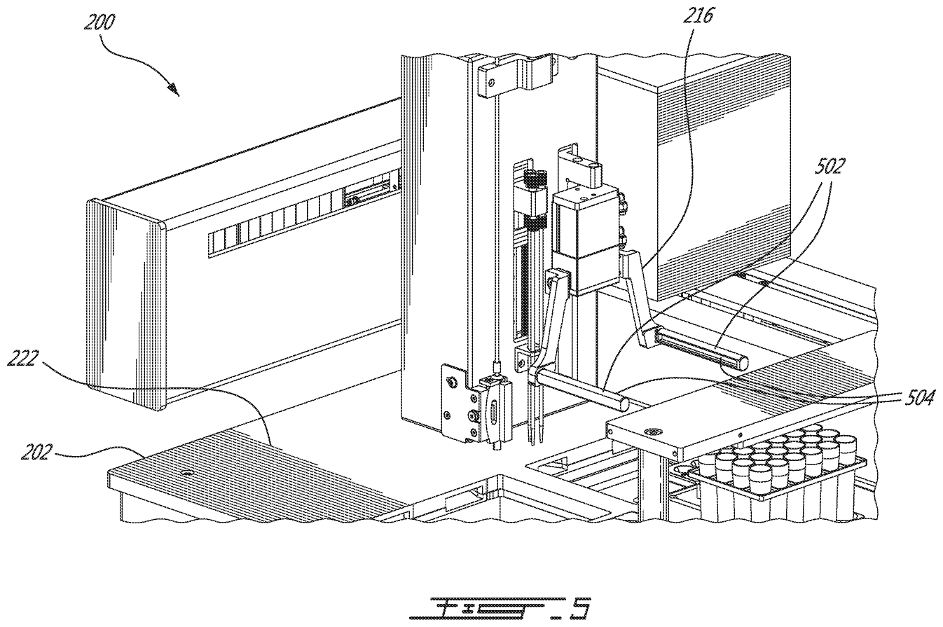

As shown, the vessels 302 are provided in an array 304 of 24 vessels. However, in some embodiments, arrays of 12, 48 or 96 samples are also possible. Other sizes of arrays are also considered. Each vessel 302 may be sized and shaped to receive about 2 mL sample, as best shown in FIG. 4. In some embodiments, the vessels 302 can be designed for small volumes, for example, 2 to 12 mL. in some other embodiments. Other volumes are also considered. In the illustrated embodiment, the vessel 302 has a pierceable end 404 and an opposite, open end 402 for receiving a sample 406.

In some embodiments, the vessels 302 are consumables. Accordingly, the vessels 302 may be compatible with injection moulding processes in order to produce the plates in an easy and affordable manner. The vessel holder 300 can be consumable, too, in some embodiments.

Moreover, in some embodiments, the vessels 302 and the vessel holder 300 are made of materials which are compatible with chemicals while being resistant to high temperatures generally experienced in conventional processes. For instance, in some embodiments, the vessels 302 and the vessel holder 300 are acid resistant and resist to up to 200° C.

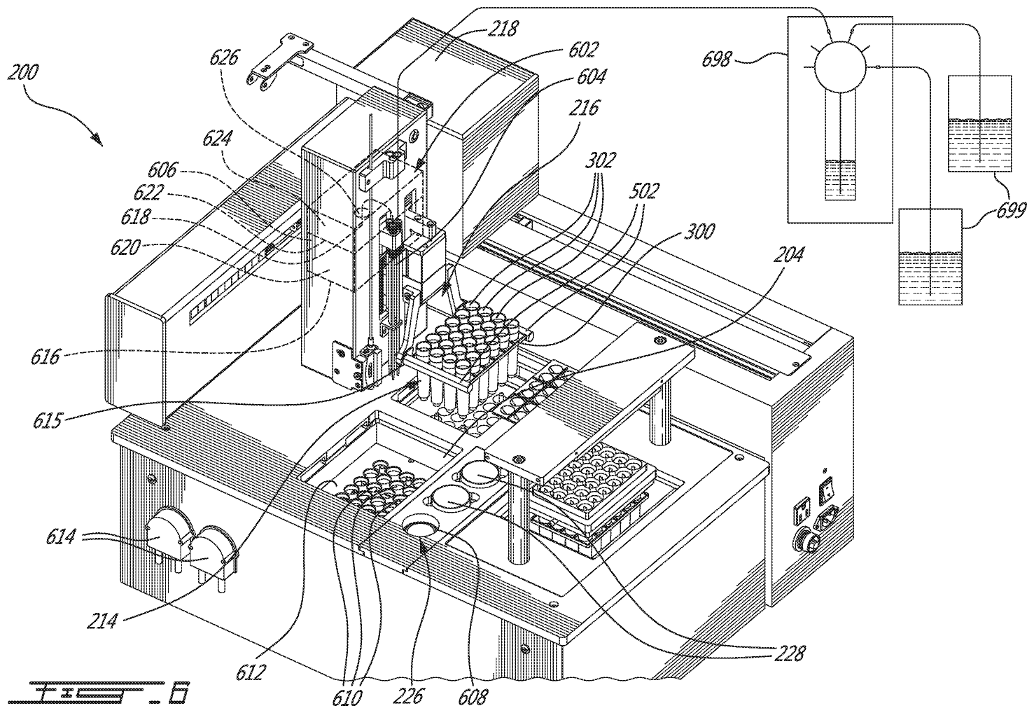

As illustrated, each vessel 302 can have a tapered shape 408 so as to be matingly engageable into a corresponding one of the vessel apertures of the vessel holder 300. The vessels 302 may be held together via the vessel holder 300, which can facilitate the manipulation of the vessel manipulating member 214 an enlarged view of which is shown in FIG. 5.

As depicted, the vessel manipulating member 214 can have two fingers 502 substantially parallel and spaced-apart from one another. In some embodiments, the fingers 502 can be parallel to a plane of the top surface 222 of the frame 202. The two fingers 502 are movable between a gripping position, in which the two fingers 502 are brought towards one another, and a release position, in which the two fingers 502 are spaced away from one another, or vice versa.

Other embodiments are also considered for the vessel manipulating member 214. For instance, the vessel manipulating member 214 can have more than two fingers 502, a single finger or no finger at all depending on the embodiment. In some embodiments, the vessel manipulating member 214 can be provided in the form of a robotized arm, a conveyor, and/or any rack engaging device suitable for displacing the vessels 302 and/or the vessel holder 300 from one station to another.

During use, the fingers 502 can grip the vessel holder 300 while in the gripping position and release the vessel holder 300 while in the release position. The fingers 502 may alternatively grip the vessels 302 directly instead of the vessel holder 300. Each finger can have a portion with gripping material 504, to enhance the grip on the vessel holder 300 and/or on the vessels 302.

Turning now to FIG. 6, the fingers 502 are shown in the gripping position holding the vessel holder 300, and transporting the vessels 302. As depicted in this example, the vessel manipulating member 214 is displacing the vessels 302 towards the reagent dispensing station 204.

In the illustrated embodiment, the reagent dispensing station 204 can be recessed from the top surface 222 of the frame 202 at the first vessel receiving region 224. The reagent dispensing station 204 can have a vessel receiving plate 612 received in the first vessel receiving region 224. The vessel receiving plate 612 can have first vessel apertures 610 which are spaced-apart from one another for receiving corresponding ones of the vessels 302.

In some embodiments, the reagent dispensing station 204 can have one or more integrated reservoirs 606 (hereinafter “the integrated reservoir”) within the frame 202. The integrated reservoir 606 can be used to contain one or more reagents for use by the reagent dispensing station 204. The integrated reservoir 606 can have a base 616, a top 622, walls 620 spacing the base 616 from the top 622 in a sealed manner, and one or more openings 626 through which reagent can be pumped or otherwise removed. In some embodiments, the integrated reservoir 606 can be partially or wholly enclosed within the housing. The integrated reservoir 606 can be closed or open to the surrounding environment. The integrated reservoir 606 can be acid-resistant in some embodiments.

The reagent dispensing station 204 can have one or more pumping assemblies 602 (hereinafter “the reagent pumping assembly”) which can be used to pump reagent from the integrated reservoir 606 in order to dispense the pumped reagent into the vessels 302.

In some embodiments, the reagent pumping assembly 602 can have one or more reagent conduits 604 (hereinafter “the reagent conduit”) in fluid communication with the integrated reservoir 606. The reagent conduit 604 can have a drawing end 618 within the integrated reservoir 606 via the opening 626 and an opposite, dispensing end 615 at the reagent dispensing station 204. The reagent conduit 604 can be provided in the form of a tube, a hose, a pipe and the like. In some embodiments, the reagent conduit 604 can be acid-resistant. The reagent conduit 604 can also be flexible. The reagent conduit 604 can have a length which allows its dispensing end 615 to extend across any position of the reagent dispensing station 204. Alternatively to having the integrated reservoir 606 or in combination therewith, external reservoirs 699 separate from the integrated system 200 may be used. Such external reservoirs 699 may store large volumes of reagents which may be added to the vessel by dispensing via the reagent dispensing station 204. Such external reservoirs 699 may also contain normalization liquid. In some embodiments, the drawing end 618 of the reagent conduit 604 may be connected to the external reservoirs 699 through a pump 698, such as a syringe pump used to dispense reagents or perform normalization.

The reagent pumping assembly 602 can have one or more pumps 624 (hereinafter “the reagent pump”) in fluid communication with the reagent conduit 604 to actively pump reagent from the drawing end 618 of the reagent conduit 604 towards the dispensing end 615 of the reagent conduit 604. The reagent pump 624 can be a positive displacement pump, an impulse pump, a syringe pump, a velocity pump, a gravity pump, a peristaltic pump, a valve-less pump and/or any other suitable type of reagent pump. The drawing end 618 and the dispensing end 615 of the reagent conduit 604 can be the same end of the reagent conduit 604 in some embodiments.

In some embodiments, one or more dispensing pumps 614 are provided for the washing station 226. One of the dispensing pumps 614 may be for pumping a cleaning agent (such as water) to the washing station 226 from a reservoir of the cleaning agent. Another of the dispensing pumps 614 may be for pumping waste cleaning agent from the washing station 226 to a waste collector container. The dispensing pumps 614 may be fluidly connected to the cleaning agent reservoir, the washing station 226, and the waste collector container via tubes.

In some embodiments, the dispensing end 615 of the reagent conduit 604 can be movable at the reagent dispensing station 204. More specifically, the dispensing end 615 of the reagent conduit 604 can be sequentially moved to a plurality of vessel positions within the reagent dispensing station 604.

In some embodiments, the dispensing end 615 of the reagent conduit 604 can be moved using the vessel manipulation unit 216. In some embodiments, the dispensing end 615 of the reagent conduit 604 can be moved using another, separate and independent conduit manipulation unit dedicated to the displacement of the reagent conduit 604. In such embodiments, the vessel manipulation unit 216 can be operated to first move the vessels 302 to a first vessel position within the reagent dispensing station 204, and the conduit manipulation unit can move the dispensing end 615 of the reagent conduit 604 towards in-position vessels, whereby the reagent can be dispensed inside each of the vessels 302 upon activation of the reagent pumping assembly 602.

Accordingly, the reagent dispensing station 204 can be operated in accordance with instructions stored on the memory of the controller 218. The dispensing of reagent into the vessels 302 can be performed sequentially, simultaneously, or a combination thereof, depending on the embodiment and on the number of reagent conduits 604, for instance.

In some embodiments, the reagent conduit 604 first moves to the integrated reservoir 606, dips into the integrated reservoir 606, sucks some reagent, moves to the vessel 302, dips into the vessel 302, dispenses the reagent, and so forth, according to preprogrammed instructions stored on the memory of the controller 218. This can be referred to as a pick and place process. More than one reagent conduit 604 can be equipped to the integrated system 200 for dispensing more than one reagent in order to avoid any cross contamination. The washing station 226 has a first reservoir 608 on the top surface 222 of the integrated system 200. The other two reservoirs 228 proximate to the washing reservoir 608 can be reagent reservoirs used in the reagent dispensing step performed by the reagent dispensing station 204. During use, dispensing ends and/or bubble stirring tips can be washed at the washing station 226 after they come out from a sample, or before dipping to a reagent reservoir.

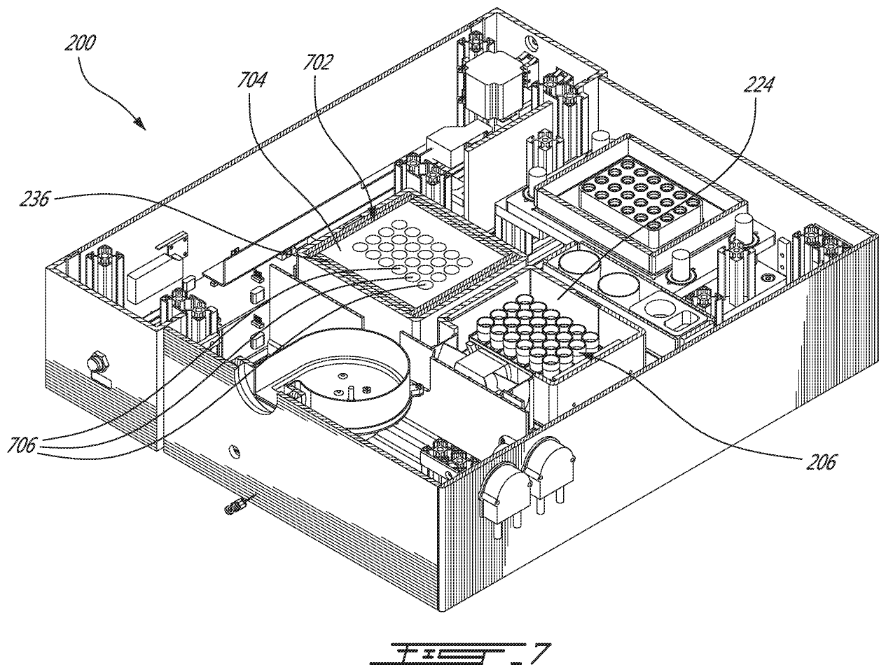

As shown in FIG. 7, the sample digestion station 206 can be recessed from the top surface 222 of the frame 202. As shown, the sample digestion station 206 is recessed at the second vessel receiving region 236 which is spaced-apart from the first vessel receiving region 224.

In some embodiments, the sample digestion station 206 can have one or more heating elements 702 (hereinafter “the heating element”) received in the second vessel receiving region 236. The heating element 702 can be provided in the form of one or more resistive conductor(s), one or more thermoelectric element(s), one or more infrared radiation source(s), one or more microwave radiation source(s) and the like. Other types of heating elements 702 can be considered. The heating element 702 can be distributed to uniformly or selectively heat the vessels 302 during use.

The sample digestion station 206 can also have a thermally conductive block 704 which is received in the second vessel receiving region 236. In some embodiments, the thermally conductive block 704 is thermally connected to the heating element 702. The thermally conductive block 704 can be provided in the form of a block of thermally conductive material such as graphite, aluminum, steel or any other metal. In some embodiments, the thermally conductive block 704 can be configured to uniformly distribute heat across the block, which can in turn heat the vessels 302 uniformly. The thermally conductive block 704 can have second vessel apertures 706 spaced-apart from one another to receive the vessels 302 during digestion.

The heating element can be activated by the controller 218 to heat the thermally conductive block 704 to high temperatures including, but not limited to, 200° C. In some embodiments, the heating element 702 can be activated by a switch or button of the integrated system 200, or otherwise be remotely activated.

Accordingly, the sample digestion station 206 can be operated in accordance with instructions stored on the memory of the controller 218. The heating of the vessels 302 can be performed sequentially, simultaneously, or a combination thereof, depending on the embodiment and on the number of independent heating elements 702, for instance.

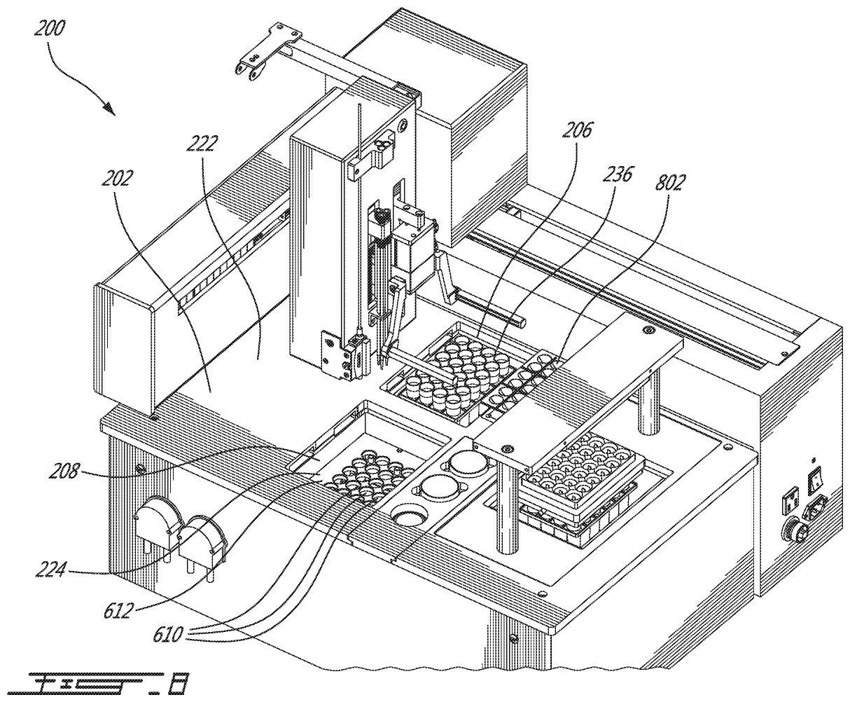

FIG. 8 shows the vessels 302 at the sample digestion station 206. During digestion of the samples, the samples can evaporate and thus lead to sample losses and/or undesirable fumes. Accordingly, in some embodiments, the sample digestion station 206 can have an evaporation stopper plate 802 which is movable between a digestion position, in which the evaporation stopper plate 802 is above the second vessel receiving region 236, and a rest position, in which the evaporation stopper plate 802 rests away from the second vessel receiving region 236, such as shown in FIG. 8.

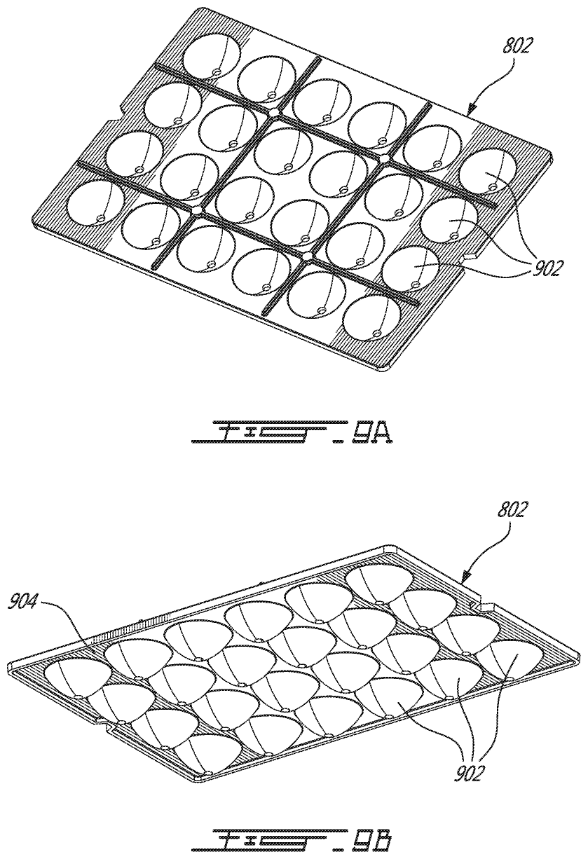

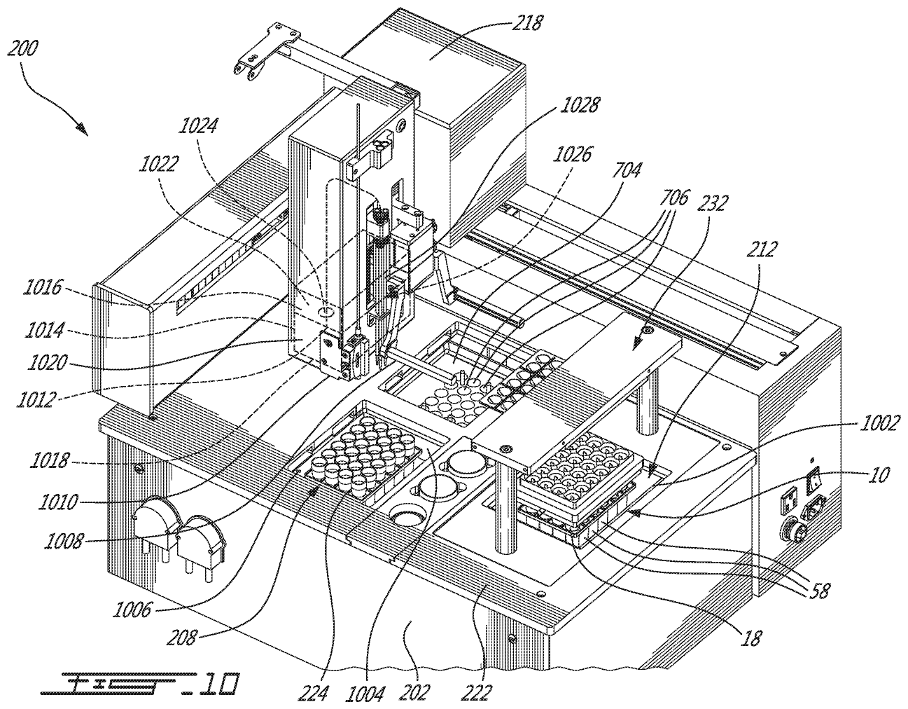

FIGS. 9A and 9B show top and bottom views of an example of the evaporation stopper plate 802. As depicted, the evaporation stopper plate 802 is sized and shaped to be received on the vessels 302. More specifically, in this example, the evaporation stopper plate 802 can be sealingly received on open surfaces of the vessels 302. In the digestion position, the evaporation stopper plate 802 can prevent evaporation from leaving the vessels 302 and can help the evaporation to condense on a portion of an undersurface of the evaporation stopper plate 802, thereby favoring the condensed fluid to drip back into the sample, and so forth, until the digestion is completed.

In some embodiments, the evaporation stopper plate 802 can have an array of bulges 902 protruding from the undersurface 904 of the evaporation stopper plate 802, such as shown in FIG. 9B. The evaporation stopper plate 802 is similar in size and shape to the vessel holder 300, such that vessels 302 in the vessel holder 300 are aligned with the bulges 902 in the evaporation stopper plate 802. When the evaporation stopper plate 802 is received in the digestion position, the bulges 902 can partially protrude within the vessels 302. In this way, the fluid that is condensed on the bulge 902 can tend to flow in a laminar fashion inwardly towards a center of the bulge 902, at which point drops may form. The drops so-formed may drip back into the sample, until the digestion is completed.

Movement of the evaporation stopper plate 802 can be operated in accordance with instructions stored on the memory of the controller 218. More than one evaporation stopper plate 802 can be considered in some embodiments. The evaporation stopper plate 802 can be moved by the vessel manipulating member 214 in some embodiments.

FIG. 10 shows the vessels 302 at the sample cooling station 208. As depicted, the sample cooling station 208 is recessed from the top surface 222 of the frame 202 at the first vessel receiving region 224.

The sample cooling station 208 can have the vessel receiving plate 612 received in the first vessel receiving region 224 (as best shown in FIG. 8). As described above, the vessel receiving plate 612 can have first vessel apertures 610 which are spaced-apart from one another for receiving corresponding ones of the vessels 302.

The sample cooling station 208 can be used to cool the samples contained inside each one of the vessels 302. As mentioned above, the cooling can be passive or active depending on the embodiment. In the illustrated embodiment, the vessels 302 can either be passively cooled by letting them interact with surrounding air, by which the temperature of the samples can tend towards the ambient temperature, or by blowing air towards (or sucking hot air away from) the vessels using a ventilation unit 220. An example of the ventilation unit 220 will be described below. In some embodiments, a gap 1004 may be provided between the vessels 302 and the first vessel receiving region 224 so as to encourage convection to occur around the vessel 302, thereby exchanging heat with the surrounding environment.

Accordingly, the sample cooling station 208 can be operated in accordance with instructions stored on the memory of the controller 218. The cooling of the vessels 302 can be performed sequentially, simultaneously, or a combination thereof, depending on the embodiment and on the number of independent thermoelectric elements, if any. For instance, the controller 218 can have instructions to maintain the vessels 302 cool at the sample cooling station 208 for a given period of time, which can depend on the digestion conditions with which digestion has been performed at the sample digestion station 206. In some embodiments, the cooling can last as long as a given temperature is reached, as can be measured by a temperature sensor 1006 installed in the recessed region of the sample cooling station 208.

Also shown in FIG. 10, the vessels 302 are at the sample normalization station 210. The sample normalization station 210 can share a location of the reagent dispensing station 204 and of the sample cooling station 208. In some embodiments, the sample normalization station 210 can have one or more normalization fluid reservoirs 1014 (hereinafter “the normalization fluid reservoir”) within the frame 202. The normalization fluid reservoir 1014 can be used to contain one or more normalization fluids (hereinafter “the normalization fluid”) for use by the sample normalization station 210. The normalization fluid reservoir 1014 can have a base 1018, a top 1016, walls 1020 spacing the base 1018 from the top 1016 in a sealed manner, and one or more openings 1024 (hereinafter “the normalization fluid opening”) through which normalization fluid can be pumped or otherwise removed. In some embodiments, the normalization fluid reservoir 1014 can be partially or wholly enclosed within the housing. The normalization fluid reservoir 1014 can be acid-resistant in some embodiments. The normalization fluid reservoir 1014 can be integrated into the integrated system 200 in some embodiments. In some other embodiments, the normalization fluid reservoir 1014 can be provided in the form of a standalone reservoir lying outside the integrated system 200 but in fluid communication to the reagent conduit 604 through tubing and pumping, for instance.

The sample normalization station 210 can have one or more pumping assemblies 1026 (hereinafter “the normalization fluid pumping assembly”) which can be used to pump normalization fluid from the normalization reservoir 1014 in order to dispense the pumped normalization fluid into the vessels 302.

In some embodiments, the normalization fluid pumping assembly 1026 can have one or more normalization fluid conduits 1028 (hereinafter “the normalization fluid conduit”) in fluid communication with the normalization fluid reservoir 1014. The normalization fluid conduit 1028 can have a drawing end 1012 within the normalization fluid reservoir 1014 via the normalization fluid opening 1024 and an opposite, dispensing end 1008 at the sample normalization station 210. The normalization fluid conduits 1028 can be provided in the form of a tube, a hose, a pipe and the like. In some embodiments, the normalization fluid conduit 1028 can be acid-resistant. The normalization fluid conduit 1028 can also be flexible. The normalization fluid conduit 1028 can have a length which allows its dispensing end 1008 to extend across any position of the sample normalization station 210.

The normalization fluid pumping assembly 1026 can have one or more pumps 1022 (hereinafter “the normalization fluid pump”) in fluid communication with the normalization fluid conduit 1028 to actively pump normalization fluid from the drawing end 1012 of the normalization fluid conduit 1028 towards the dispensing end 1008 of the normalization fluid conduit 1028. The normalization fluid pump 1022 can be a positive displacement pump, an impulse pump, a syringe pump, a velocity pump, a gravity pump, a peristaltic pump, a valve-less pump and/or any other suitable type of pump.

In some embodiments, the dispensing end 1008 of the normalization fluid conduit 1028 can be movable within the sample normalization station 210. More specifically, the dispensing end 1008 of the normalization fluid conduit 1028 can be sequentially moved to a plurality of vessel positions within the sample normalization station 210.

In some embodiments, the dispensing end 1008 of the normalization fluid conduit 1028 can be moved using the vessel manipulation unit 216. In some embodiments, the dispensing end 1008 of the normalization fluid conduit 1028 can be moved using another, separate and independent conduit manipulation unit dedicated to the moving of the normalization fluid conduit 1028. In such embodiments, the vessel manipulation unit 216 can be operated to first move the vessels 302 to a second vessel position within the sample normalization station 210, and then the conduit manipulation unit can move the dispensing end 1008 of the normalization fluid conduit 1028 towards the in-position vessels 302, whereby the normalization fluid can be dispensed inside each of the vessels 302 upon activation of the normalization fluid pumping assembly 1026.

Accordingly, the sample normalization station 210 can be operated in accordance with instructions stored on the memory of the controller 218. The dispensing of normalization fluid into the vessels 302 can be performed sequentially, simultaneously, or a combination thereof, depending on the embodiment and on the number of normalization fluid conduits 1028, for instance.

As mentioned above, the sample normalization station 210 can be configured to determine remaining volumes Vᵣ of the samples inside each of the vessels 302 and to normalize the volumes of the samples to a predetermined normalized level Vₙ, i.e., by dispensing a given volume Vₐ of a normalization fluid inside each of the vessels 302 corresponding to the predetermined normalized level Vₙ minus the remaining volume Vᵣ as measured (Vₐ=Vₙ−Vᵣ).

The remaining volumes Vᵣ can be measured using one or more level sensors 1010 (hereinafter “the level sensor”) of the sample normalization station 210. The level sensor 1010 can be a point level sensor and/or a continuous level sensor. Examples of such level sensors 1010 can include, but are not limited to, optical level sensor(s), laser level sensor(s), ultrasonic level sensor(s), capacitance level sensor(s), hydrostatic pressure level sensor(s) and the like.

In some embodiments, the level sensor 1010 can be moved using the vessel manipulation unit 216. In some embodiments, the level sensor 1010 can be moved using another, separate and independent sensor manipulation unit dedicated to the moving of the level sensor. In such embodiments, the vessel manipulation unit 216 can be operated to move the vessels 302 to the sample normalization station 210, and then the sensor manipulation unit can move the level sensor towards the in-position vessels, whereby the remaining volume Vᵣ inside each of the vessels 302 can be measured.

Accordingly, when the vessels 302 are moved to the sample normalization station 210, the normalization fluid pumping assembly 1026 can add normalization fluid inside each one of the vessels 302 in accordance with instructions stored on the memory of the controller 218 based on the measured remaining volumes Vᵣ. The predetermined normalized level Vₙ can be stored on the memory of the controller 218 or be received from a remote network.

Still referring to FIG. 10, the sample filtration station 212 may be recessed from the top surface 222 of the frame 202 to define a third vessel receiving region 1002. In this specific embodiment, the sample filtration station 212 can have a removable filtering system 10 received in the third vessel receiving region 1002. As shown, the sample filtration station 212 can have recipients vessels 58 on which is received the removable filtering system 10.

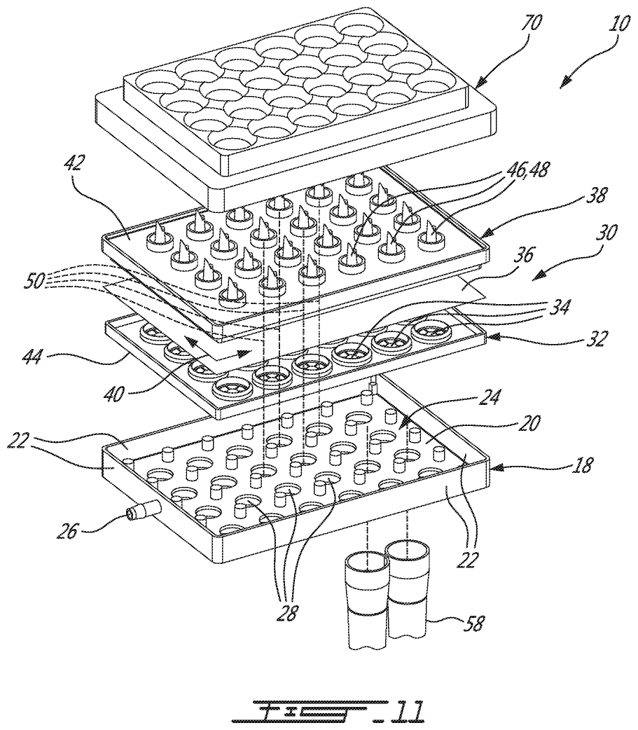

FIG. 11 shows an example of the filtering system 10. As depicted, the filtering system 10 can have a vacuuming plate 18 with a base 20, walls 22 extending from the base 20 to define a cavity 24, and a vacuum port 26 in fluid communication with the cavity 24. In some embodiments, the vacuum port 26 is used to pull air from the cavity 24. The base 20 can have outlet openings 28 which are spaced-apart from one another in this example.

As illustrated, the filtering system 10 can have a filtering unit 30 which is removably mounted to the vacuuming plate 18 and which encloses the cavity 24 when so-mounted. The filtering unit 30 can have a filter plate 32 with filter openings 34 aligned with the outlet openings 28 of the vacuuming plate 18 to allow fluid flow therebetween.

The filtering unit 30 can have a filtering membrane 36 which covers the filter openings 34 of the filter plate 32. The filtering membrane 36 is adapted to prevent a solid portion of the sample from passing through the filtering membrane 36 while allowing a fluid portion of the sample to flow through the filtering membrane 36. The fluid portion of the sample is also referred to as the “filtered sample” in this disclosure.

As depicted, the filtering unit 30 can also have a piercing plate 38 which is removably received on the filter plate 32 and which sandwiches the filtering membrane 36 between the filter and piercing plates 32 and 38. As such, the filtering membrane 36 lies in a plane 40 extending between top and bottom surfaces 42 and 44 of the filtering unit 30 in this example. As shown, the piercing plate 38 can have vessel piercing members 46 which extend away from the filtering membrane 36. Each vessel piercing member 46 can have a respective conduit 48 extending through the piercing plate 38 and aligned with a corresponding one of the filter openings 34 of the filter plate 32 to allow fluid flow therebetween.

Accordingly, when the filtering unit 30 is mounted to the vacuuming plate 18, the conduits 48 of the vessel piercing members 46 of the piercing plate 38, the filter openings 34 of the filter plate 32 and the outlet openings 28 of the vacuuming plate 18 are aligned with one another. Such an alignment defines fluid flow paths 50 extending through the conduits 48, through corresponding portions of the same filtering membrane 36, through the filter openings 34 and through the outlet openings 28 of the vacuuming plate 18. The outlet openings 28 of the vacuuming plate 18 are aligned with the recipients vessels 58 to allow fluid communication therebetween.

Accordingly, upon vacuum, the sample as filtered through the membrane 36 is received in a corresponding recipient vessel 58 located below the vacuuming plate 18 and aligned with the outlet openings 28 to allow fluid flow therethrough, after which the filtered sample 12 can be collected for subsequent uses.

An example of the filtering system 10 is thoroughly described in U.S. Provisional Patent Application Ser. No. 62/818,837, the content of which is hereby incorporated by reference. Other examples of filtration systems 10 can be considered, as seen fit for one or more other applications.

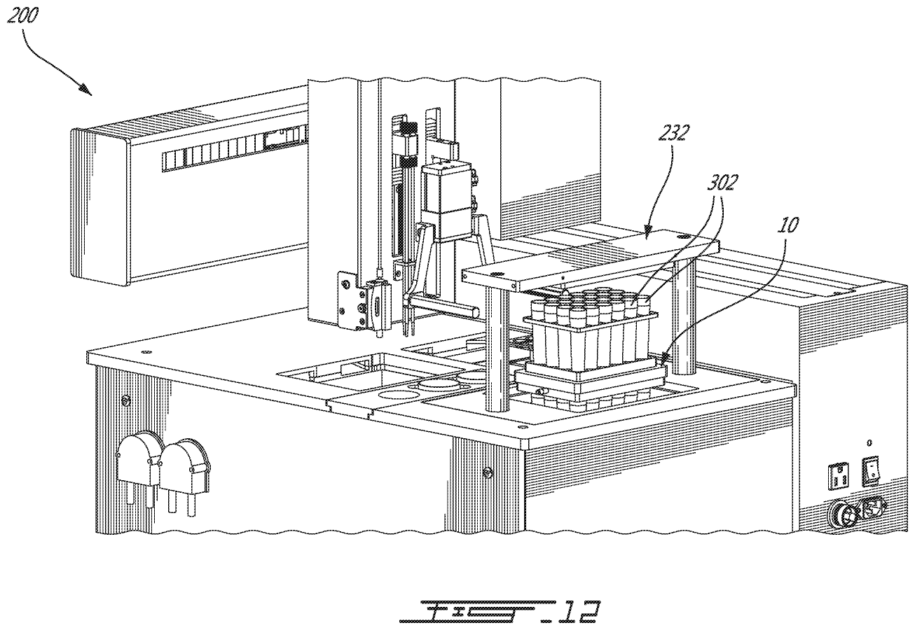

FIG. 12 shows the vessels 302 at the sample filtration station 212. As shown, the integrated system 200 can have a vessel pressing plate 232 movable between a pressing position, in which the vessel pressing plate 232 is brought towards the filtering system 10, and a rest position, in which the vessel pressing plate 232 rests away from the filtering system 10.

When the vessels 302 are received on the filtering system 10, the vessel pressing plate 232 can be moved to the pressing position and thereby apply a pressure on the vessels 302 which in turn causes them to be pierced by corresponding ones of the vessel piercing members 46 of the piercing plate 38. In this specific embodiment, the filtering process is initiated by moving the vessels 302 onto the filtering system 10 and then by moving the vessel pressing plate 232 into the pressing position.

In some embodiments, the vessel pressing plate 232 can be moved using the vessel manipulation unit 216. In some embodiments, the vessel pressing plate 232 can be moved using another, separate and independent pressing plate displacement unit dedicated to the displacement of the vessel pressing plate 232. The pressing plate displacement unit is configured to force the vessels 302 against the piercing plate of the filtering system 10 with sufficient strength in order that the vessels 302 be pierced by corresponding ones of the vessel piercing members 46. In such embodiments, the pressing plate displacement unit can be operated by the controller 218 to first displace the vessel pressing plate 232 between the pressing position and the rest position.

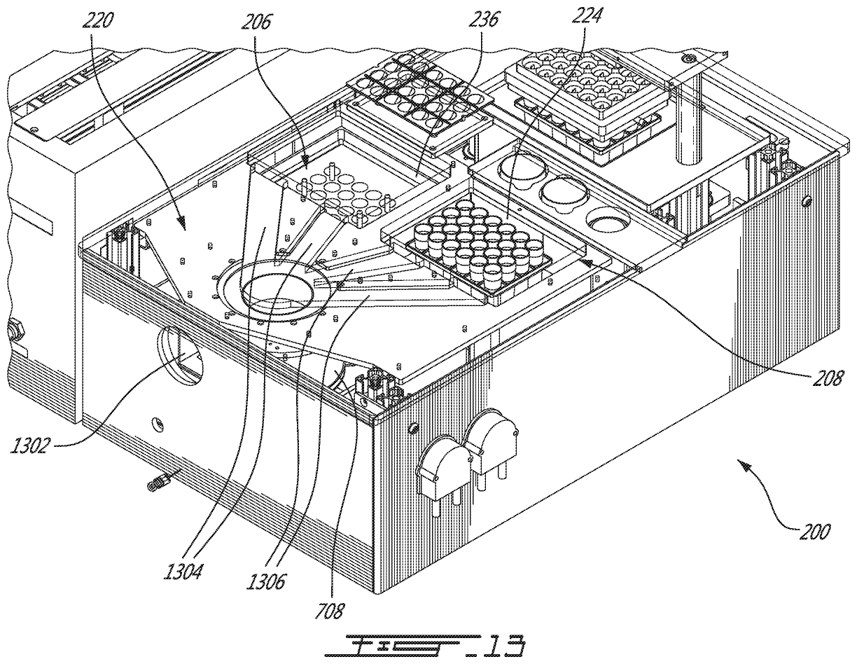

FIG. 13 shows an example of a ventilation unit 220 of the integrated system 200. As depicted, the ventilation unit 220 can have one or more ventilation conduits 1304, 1306 extending between at least one of the stations 204, 206, 208, 210, 212 and an exhaust port 1302 extending through the frame 202. The ventilation conduits 1304, 1306 can be wholly or partially housed within the housing of the integrated system 200. The number of ventilation conduits 1304, 1306 can depend on the implementation.

In the illustrated embodiments, the ventilation conduits 1304, 1306 can have first ventilation conduits 1304 extending between the sample cooling station 208 and the exhaust port 1302. Second ventilation conduits 1306 extending between the sample digestion station 206 and the exhaust port 1302 can also be provided. A hose may be installed to guide the fumes from the exhaust port 1302 to outdoors.

In some embodiments, the first and second ventilation conduits 1304, 1306 extend between a respective one of the first and second vessel receiving regions 224, 236 and the exhaust port 1302. More specifically, the ventilation conduits 1304, 1306 can extend from the recessed regions of the sample digestion and cooling stations 206, 208.

In this way, undesirable fumes that exit from the vessels 302, whenever they are at the sample digestion station 206 or sample cooling station 208, can be drawn under the top surface 222 of the frame 202 towards the exhaust port 1302. Using such a ventilation unit 220 may reduce the need for a hood fume, which can be inconvenient at least in terms of cost, footprint and obstructiveness in a laboratory environment. Such ventilation may prevent fumes from corroding the Z and Y axes of the instrument(s). The ventilation may also serve as a cooling means by drawing away hot air around the vessels.

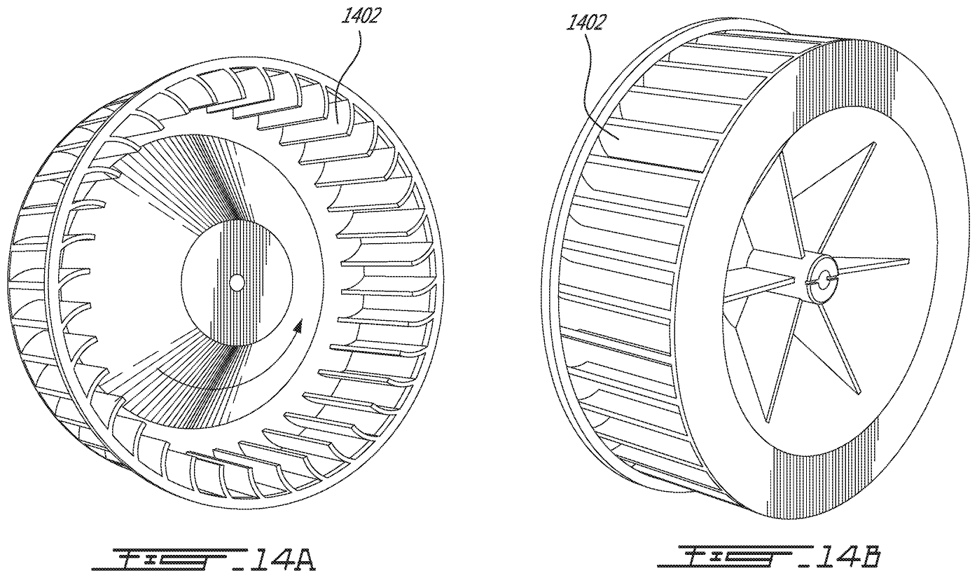

The ventilation unit 220 can have a cavity 1308 in fluid communication with the ventilation conduits 1304, 1306. The cavity 1308 can be sized and shaped to receive a fluid blower blowing fluid in or out of one or more of the stations, from or towards the exhaust port 1302. FIGS. 14A and 14B show an example of the fluid blower, which is in this case provided in the form of a blower fan 1402. However, in some other embodiments, other types of fluid blower can be considered. For instance, in alternate embodiments, the exhaust port 1302 can be in fluid communication with a vacuum pump creating a vacuum in the cavity 1308, and hence in the ventilation conduits 1304, 1306, via the exhaust port 1302.

The fluid blower may be operated in both directions. In other words, the fluid blower can be operated to draw fluid from the sample digestion station 206 towards the exhaust port 1302 to draw undesirable fumes from the vessels 302 via the first ventilation conduits 1304, for instance. In some embodiments, the fluid blower can be operated to draw fluid from the sample cooling station 208 towards the exhaust port 1302 to draw undesirable fumes from the top of the vessels 302 during the cooling process, via the second ventilation conduits 1306, for instance. In some embodiments, the fluid blower can be operated to blow fluid from the exhaust port 1302 towards the sample cooling station 208 to cool the vessels 302 via the second ventilation conduits 1306, for instance. In these embodiments, a thermoelectric element can be provided to cool air within the second ventilation conduits 1306, to increase the rate at which the vessels 302 are cooled by the ventilation unit 220. A fluid valve can be provided to selectively open or close either one of the first and second ventilation conduits 1304, 1306. One or more third ventilation conduits can also be provided. In such embodiments, the vessels 302 can be cooled by blowing cold fluid thereon via the first ventilation conduits 1304 while removing any undesirable fumes away from the vessels 302 using the third ventilation conduit(s).

The ventilation unit 220 can be operated in accordance with instructions stored on the memory of the controller 218. For instance, the ventilation unit 220 can be operated to ventilate either one or both of the first and second ventilation conduits 1304, 1306, if desired.

All of the pumps described herein may be equipped with multi-port valves so as to allow one pump to be permanently connected to several reservoirs, such as one or more reagents reservoirs 228, one or more integrated reservoirs 606, one or more washing reservoir 608, one or more normalization fluid reservoirs 1014, one or more cleaning agent reservoir, one or more external reservoir 699, and the like.

The above description is meant to be exemplary only, and one skilled in the art will recognize that changes may be made to the embodiments described without departing from the scope of the invention disclosed. Still other modifications which fall within the scope of the present disclosure will be apparent to those skilled in the art, in light of a review of this disclosure.

The controller 118, 218 as described herein may be implemented in a high level procedural or object oriented programming or scripting language, or a combination thereof. Alternatively, the controller 118, 218 may be implemented in assembly or machine language. The language may be a compiled or interpreted language. Program code for implementing the controller 118, 218 may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the controller 118, 218 may also be considered to be implemented by way of a non-transitory computer-readable storage medium having a computer program stored thereon. The computer program may comprise computer-readable instructions which cause a computer, or more specifically the controller 118, 218 of the integrated system 100, 200, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Although the stations 204, 206, 208, 210, 212 described herein are shown to be spaced-apart from one another, the positions of the stations 204, 206, 208, 210, 212 can coincide with one another, i.e. be co-located.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. An integrated system for processing vessels containing samples, the integrated system comprising:
a frame;
a reagent dispensing station, a sample digestion station, a sample cooling station, a sample normalization station and a sample filtration station within the frame;
a vessel manipulation unit having a vessel manipulating member displacing the vessels containing the samples between the reagent dispensing station, the sample digestion station, the sample cooling station, the sample normalization station and the sample filtration station; and
a controller communicatively coupled to the vessel manipulation unit, the controller having a processor and a memory having stored thereon instructions which when executed by the processor displace the vessels containing the samples from one station to another.

2. The integrated system of claim 1, further comprising a ventilation unit having:
at least one ventilation conduit extending between at least one of the stations and an exhaust port extending through the frame;
a cavity in fluid communication with the ventilation conduit; and
a fluid blower received in the cavity blowing between the one of the stations and the exhaust port.

3. The integrated system of claim 2, wherein the at least one ventilation conduit is recessed from a top surface of the frame.

4. The integrated system of claim 1, wherein at least two of the stations are co-located within the frame.

5. The integrated system of claim 1, wherein the controller is communicatively coupled to at least one of the stations.

6. The integrated system of claim 1, wherein the vessel manipulating member comprises at least two parallel and spaced-apart fingers, the at least two fingers actuatable between a gripping position, in which the at least two fingers are brought towards one another, and a release position, in which the at least two fingers are spaced away from one another.

7. The integrated system of claim 6, wherein the at least two fingers of the vessel manipulating member are at least partly covered with a gripping material.

8. The integrated system of claim 1, wherein the reagent dispensing station comprises a reagent reservoir within said frame, and a first pumping assembly pumping reagent from the reagent reservoir to a first vessel position within the reagent dispensing station.

9. The integrated system of claim 8, wherein said instructions comprise moving the vessel manipulating member to the first vessel position and activating the first pumping assembly to dispense reagent from the reagent reservoir to the first vessel position.

10. The integrated system of claim 1 wherein the sample cooling station is recessed from a top surface of the frame and defines a first vessel receiving region.

11. The integrated system of claim 10 wherein the sample cooling station comprises a vessel receiving plate in the first vessel receiving region, the vessel receiving plate having first vessel apertures spaced-apart from one another.

12. The integrated system of claim 1, wherein the sample digestion station is recessed from a top surface of the frame and defines a second vessel receiving region, the sample digestion station having a heating element in the second vessel receiving region.

13. The integrated system of claim 12, wherein the sample digestion station comprises a thermally conductive block in the second vessel receiving region, the thermally conductive block having second vessel apertures spaced-apart from one another and thermally connected to the heating element.

14. The integrated system of claim 12 wherein the sample digestion station comprises an evaporation stopper plate movable between a digestion position, in which the evaporation stopper plate is above the second vessel receiving region, and a rest position, in which the evaporation stopper plate rests away from the second vessel receiving region.

15. The integrated system of claim 1, wherein the sample normalization station comprises a normalization fluid reservoir within said frame, and a second pumping assembly for pumping normalization fluid from the normalization fluid reservoir to a second vessel position within the sample normalization station.

16. The integrated system of claim 15, wherein said sample normalization station comprises at least one level sensor measuring remaining volumes of the samples after digestion.

17. The integrated system of claim 1, wherein the sample filtration station is recessed from a top surface of the frame and defines a third vessel receiving region.

18. The integrated system of claim 1, wherein the sample filtration station comprises a filtering system in the third vessel receiving region, the filtering system comprising:
a vacuuming plate having a vacuum port extending therefrom, the vacuuming plate defining a cavity; and
a filtering unit mounted to the vacuuming plate and enclosing the cavity.

19. The integrated system of claim 18, wherein the filtering system comprises a plurality of recipients vessels on which are received the vacuuming plate.

20. The integrated system of claim 17, further comprising a vessel pressing plate movable between a pressing position, in which the vessel pressing plate is brought towards the vessels, and a rest position, in which the vessel pressing plate rests away from the vessels.
